(19) United States
(12) Patent Application Publication
(10) Pub. No.: US 2025/0382982 A1
(43) Pub. Date: Dec. 18, 2025

(54) CRANE MAT FASTENING SYSTEM

(71) Applicant: BEST BLADE RECYCLING, LLC, ABILENE, TX (US)

(72) Inventor: MICHAEL DENSON, Abilene, TX (US)

(73) Assignee: BEST BLADE RECYCLING, LLC, ABILENE, TX (US)

(21) Appl. No.: 19/208,039

(22) Filed: May 14, 2025

Related U.S. Application Data
(60) Provisional application No. 63/661,444, filed on Jun. 18, 2024.

(51) Int. Cl. F16B 5/00; E01C 9/08; F16B 33/00; F16B 43/00

(52) U.S. Cl. CPC F16B 5/0088; E01C 9/086; F16B 33/00; F16B 43/00

(57) ABSTRACT

A fastening system may include a union plate with four perforated holes aligned with mat corners. A device may include threaded receiver nuts within the perforated holes of the union plate. A device may include a tapered bolt with a threaded end, configured to engage the receiver nuts. A device may include a rubber washer and a tapered steel washer with a tapered center hole, arranged in the bolt assembly.

### FIELD OF THE INVENTION

This invention relates to modular load-bearing systems, specifically a fastening system for constructing crane mats and load surfaces from recycled wind turbine blades, utilizing hardware components such as union plates, tapered bolts, washers, and nuts for secure and adjustable assembly.

### BACKGROUND OF THE INVENTION

Recycling wind turbine blades to produce crane mats offers an environmentally sustainable, durable solution for supporting heavy construction and transportation activities. To ensure stability and safety, these mats must be securely joined in linear and grid configurations. Current fastening methods face challenges related to complexity, environmental sustainability, or load capacity. An improved, adaptable, and reusable fastening system capable of securely connecting recycled wind turbine-based mats is needed to address these issues.

### SUMMARY OF THE INVENTION

The present invention discloses a modular Crane Mat Fastening System comprising union plates, tapered bolts, washers, and nuts designed for secure, adjustable connection of recyclable wind turbine blade mats. The system enables end-to-end and multi-mat arrangements, using embedded or welded receiver nuts and tapered hardware to facilitate precise alignment, strong load transfer, and reusability. The system supports various configurations—including linear and grid arrangements—with components adaptable to different mat thicknesses and environmental conditions.

### BRIEF DESCRIPTION OF THE DRAWINGS

The drawings presented herein are for illustrative purposes only and do not limit the scope of the claims. Rather, the drawings are intended to help enable one having ordinary skill in the art to make and use the claimed inventions. The drawings are drawn to scale.

FIG. 1 is a perspective view of an exploded view a union plate with perforated holes and threaded nuts;

FIG. 2 is a perspective view of a union plate with perforated holes and attached threaded nuts;

FIG. 3 is an exploded view of a bolt attaching to a threaded nut on a union plate;

FIG. 4 is a cross sectional view of a bolt attaching to a threaded nut on a union plate; and

FIG. 5 is a plan view of 4 crane mats joined together using a union plate with only 2 receiver nuts and a that enables 2 crane mats to be secured together when laid in an end to end fashion.

### DETAILED DESCRIPTION OF THE INVENTION

A detailed description will now be provided. The purpose of this detailed description, which includes the drawings, is to satisfy the statutory requirements of 35 U.S.C. § 112. For example, the detailed description includes a description of inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that issues therefrom.

The present invention discloses a “Crane Mat Fastening System” which has the following features. In a particular illustrative embodiment of the invention, a crane mat fastening system is provided. In one example the crane mat fastening system provides an assembly of four crane mats constructed from recycled wind turbine spar material will be joined together using this fastening system. The assembly of the crane mat by using a union plate includes but is not limited to a union plate fastener is rectangular, 0.25″ A36 steel, or any other suitable material and thickness; two crane mats that are fastened together end to end using a union plate that requires only two receiver nuts. The plate is perforated with 4 holes to allow the coarse threaded nuts or any other suitable threaded receiver to be centered on the pre-perforated holes and welded securely. The perforated notches differ to assist with the orientation of the plate during the alignment of the crane mat system.

The crane mat is secured to the union plate by tapered bolts that pass through a rubber washer, followed by a tapered steel washer, into a beveled hole at each crane mat's corner, compressing the components together. Bolts, nuts, steel washers, and rubber washers can be made from any necessary diameter, thickness, or length to accommodate the variable thickness of the recycled wind turbine blade material. The union plate with 2 threaded receivers is used to join mats in sequence linearly. To lock the crane mat to the union plate by using, a tapered bolt with a 0.75″ diameter or any other appropriate size is put into each union plate nut to secure the crane matting. The tapered bolt is threaded into each nut of the union plate through an A36 steel washer with a tapered center hole to enable the bolt to countersink. The steel washer is also tapered on the bottom side of its outer diameter to allow for it to countersink into the tapered hole in the joining corner of the crane mat. The rubber or any other suitable material washer of any necessary thickness is placed between the tapered steel washer and the nut. The nut of any necessary size is welded to the union plate, protruding through the joining corner of the crane mat. When the bolt is securely tightened in the assembly, the tapered edge of the steel washer will compress the crane mat down into the union plate. The 4-way union plate is used to join an array of (4) crane mats.

The beveled nature of the fasteners enabling a flush mounted surface at the top of the mats. The two crane mats can be fastened together end to end using a union plate that requires only two receiver nuts, which is perforated with four holes to allow the coarse threaded nuts or any other suitable threaded receiver. The union plate featuring two threaded receivers used to join the mats in a linear sequence. The tapered bolt, typically with a 0.75″ diameter or another appropriate size, is inserted into each union plate nut, threading through an A36 steel washer that has a tapered center hole to enable countersinking. The tapered steel washer is also designed with a tapered bottom side on its outer diameter, allowing it to countersink into the tapered hole at the joining corner of the crane mat, while a rubber or suitable material washer of any necessary thickness is placed between the tapered steel washer and the nut.

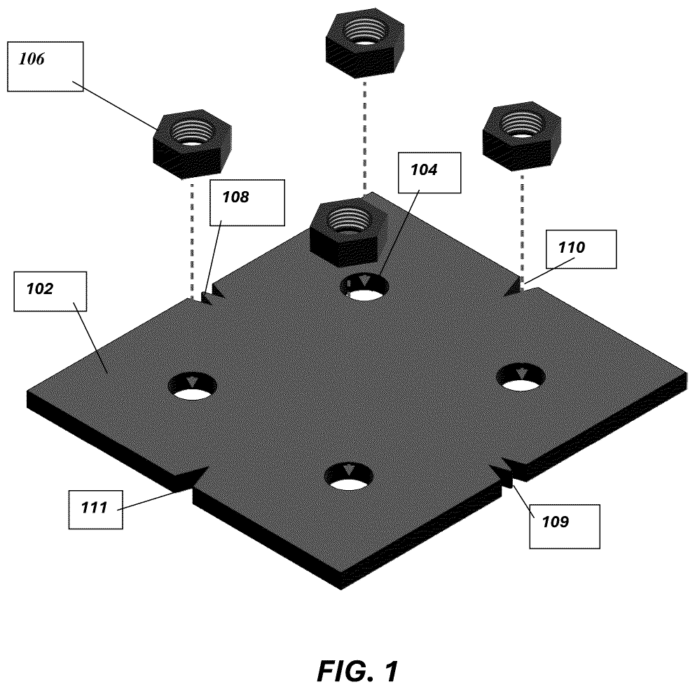

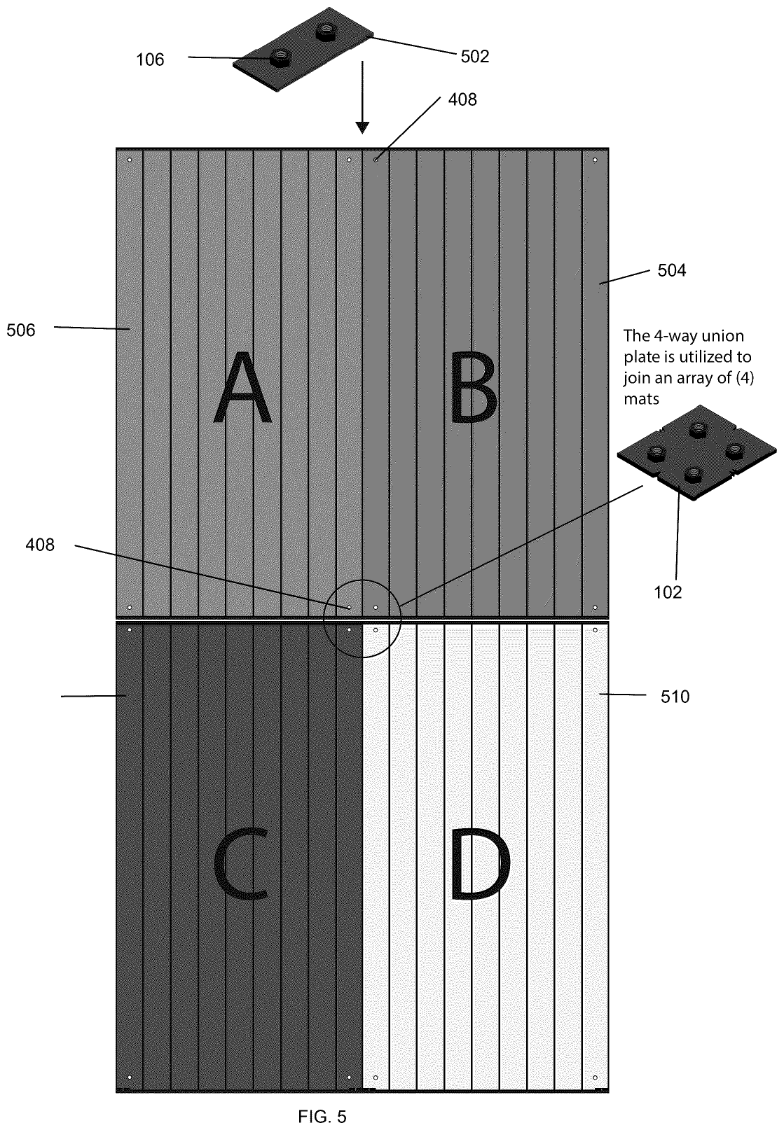

The following figures demonstrate the crane mat fastening system wherein the mats are to be held together by a union plate 106 at its corners. Turning now to FIG. 1, in a particular illustrative embodiment of the invention, a union plate fastener 102 is rectangular, 0.25″ A36 steel or any other suitable material and thickness. 4 holes 104 are be perforated into the union plate 102 to allow for coarse threaded nuts 106 or any other suitable threaded receiver to be centered on the pre-perforated holes and welded securely to plate 102. 4 crane mats 504, 506, 508 and 510 constructed from recycled wind turbine spar material are joined together using union plate 102. Utilizing a union plate 502 (see FIG. 5) with only 2 receiver nuts 106 enables 2 crane mats 504 and 506 to be secured together when laid in an end to end fashion. Tapered bolts 402 pass through a tapered steel washer 404 and then a rubber washer 406 into a beveled hole 408 within the corner of each crane mat to compress the components together and secure the crane mat to the union plate. The bolts, steel washers, rubber washers, and nuts can be any necessary diameter, thickness, or length necessary to achieve a suitable to the variable thickness of the recycled wind turbine blade material. Note the triangular notches 108 and 110 perforated in the steel union plate assist with alignment of the crane mat system during deployment.

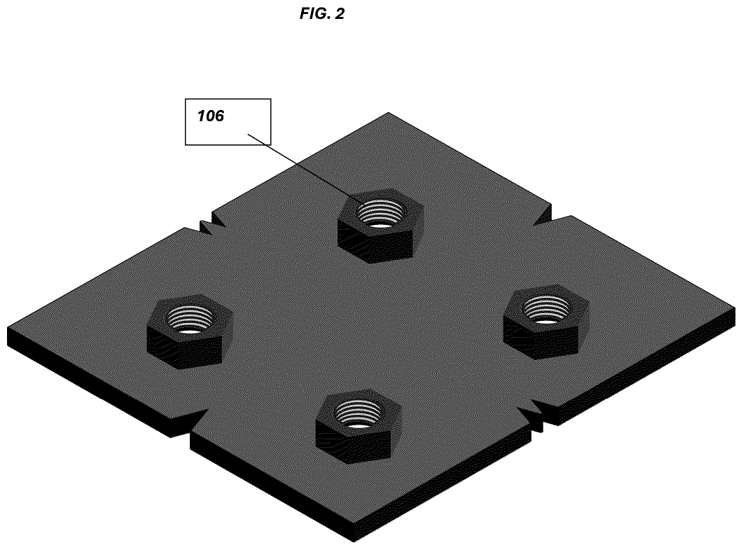

Turning now to FIG. 2, FIG. 2 depicts the union plate with the 4 nuts welded over the pre-perforated holes. Note that the perforated notches 108 and 109 differ from perforated notches 110 and 111 differ in order to assist with orientation of the unition plate during alignment of the crane mat system. Notches 108 and 109 each have two opposing triangular cuts and notches 110 and 111 each have 1 triangular cut.

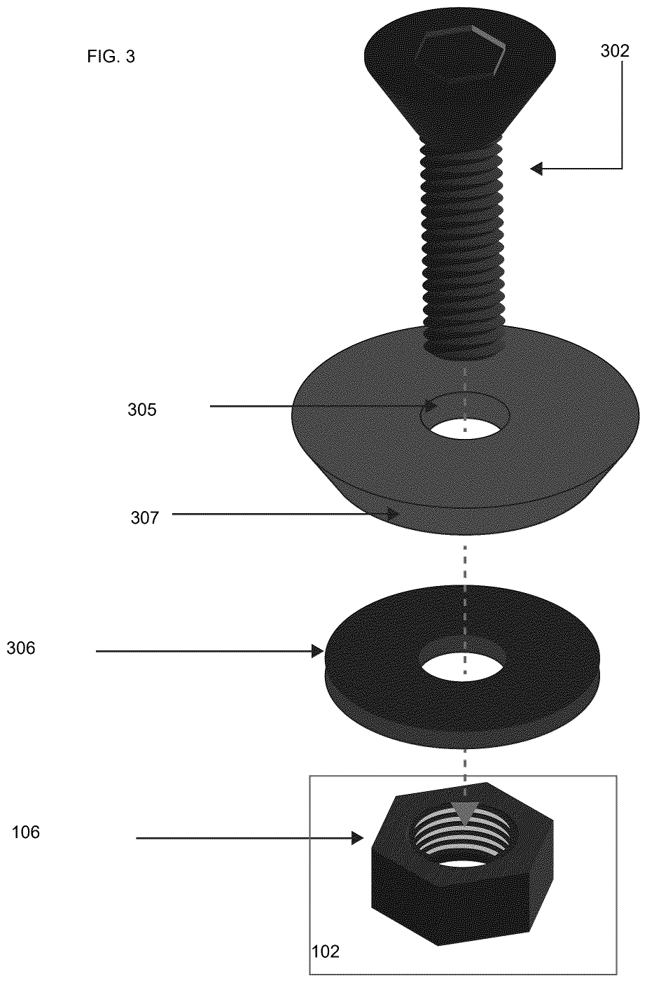

Turning now to FIG. 3, as shown in FIG. 3 to lock the crane mat to the union plate 102 a tapered bolt 302 of 0.75″ diameter or any other suitable size is threaded into each nut 106 of the union plate through an A36 steel washer 304 that is tapered in its center hole to allow for the bolt to countersink into the tapered hole 406 in the spar material of the crane mat surface. The steel washer 404 is also tapered on the bottom side of its outer diameter to allow for it to countersink into the tapered hole 408 in the joining corner of the crane mat. A rubber or any other suitable material washer 406 of any necessary thickness is placed between the tapered steel washer and the nut. When the bolt is securely tightened in the assembly the tapered edge of the steel washer will compress the crane mat down into the union plate 102.

A beveled bolt 302 to allows countersink the bolt 302 into tapered steel washer. Inside of steel washer 305 is tapered to allow bolt 302 to countersink into the steel washer. An outer diameter 307 of steel washer 304 is tapered to allow for it to countersink within the hole of the crane mat. A rubber washer 306 of any necessary thickness is utilized between the steel washer and the threaded nut 106. Nut of any necessary size is welded to the union plate that protrudes through the joining corner of the crane mat.

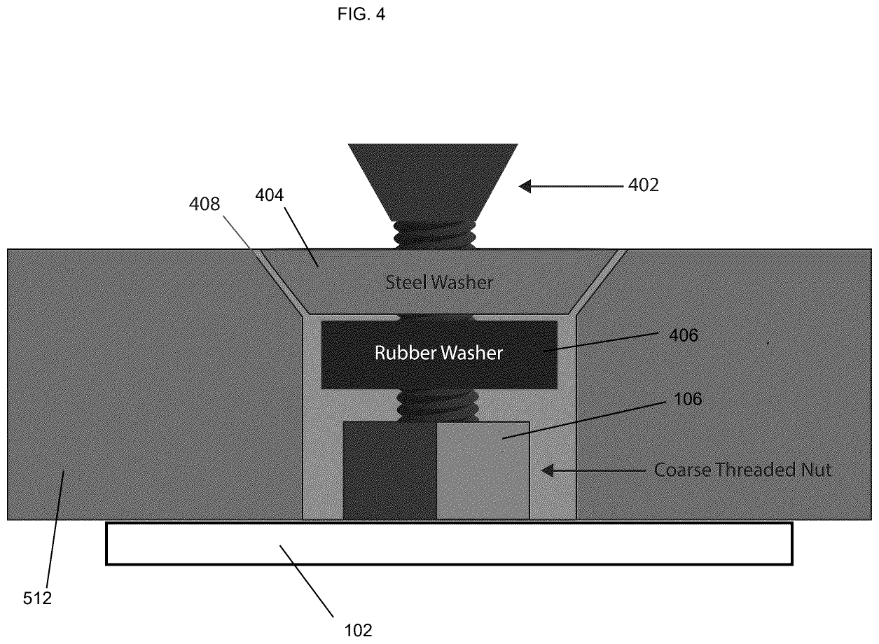

Turning now to FIG. 4, as shown in FIG. 4, depicts a side view of the hardware assembly into the crane mat. The beveled edge of the steel washer is visible profiling into the beveled edge of the tapered hole 408 through the spar material on a corner of the crane mat. As the bolt is tightened this will compress all the components together and lock them in place

Turning now to FIG. 5 a 106 union plate with (2) threaded receivers is utilized when joining crane mats 504 and 506 in sequence linearly. The 4-way (4-hole) union plate 102 is utilized to join an array of (4) crane mats 504, 506, 508 and 510.

In a particular illustrative embodiment of the invention, a system and method of the present invention is used for constructing crane mats and load-bearing surfaces using modular and recycled materials like wind turbine blades. The crane mats, made from multiple structural pieces joined by bolts and nuts, feature a borehole system to ensure secure assembly while keeping the fasteners within the edges. The system also includes sloping lips with interlocking joints for easy assembly, where uniformly spaced openings allow for the use of various fastening devices, such as bolts, pins, or clamps. Additionally, the mats are enhanced with top and bottom surface plates, ranging from ⅛ to ½ inches in thickness, which are securely attached using adhesives, welding, or screws, contributing to greater structural strength. These plates, manufactured from the same or compatible materials as the mats, further increase durability and load-bearing capacity.

The method of recycling wind turbine blades into crane mats exemplifies sustainable innovation. Spars are cut, pre-perforated, and fastened together using bolts, circular welding rings, and other hardware, ensuring legal transportation dimensions and allowing the mat to articulate along both axes. Vertical support arms and system pins provide stability during blade cutting, maintaining structural integrity. The two-pronged connector system, designed for flexibility, joins mat panels through a single hole, with upper and lower members securing the connection. This system can be adapted using various configurations, including four-pronged options, to cater to different panel arrangements. Each component can be assembled using common techniques like welding or screwing, ensuring a strong and flexible hold. Lastly, the load-bearing surface system features modular panels with connector assemblies that secure them in side-by-side or end-to-end configurations. Adjustable torque bolts ensure a rigid connection, while brace plates, recessed in the panels, distribute forces evenly and enhance the overall structural integrity. This combination of well-designed connector assemblies and strategically placed brace plates ensures the system can withstand heavy loads and provide consistent, stable support.

The fastener is made of 25″ A36 steel or any other suitable material and thickness. The perforated notches on the union plate assist with the orientation during the alignment of the crane mat system. The tapered bolt secures the matting through a washer with a tapered hole. The nut, welded to the union plate and protruding through the joining corner of the crane mat, compresses the crane mat down into the union plate when the bolt is securely tightened in the assembly.

The two crane mats can be fastened together end to end using a union plate that requires only two receiver nuts, which is perforated with four holes to allow the coarse threaded nuts or any other suitable threaded receiver. The union plate featuring two threaded receivers used to join the mats in a linear sequence. The tapered bolt, typically with a 0.75″ diameter or another appropriate size, is inserted into each union plate nut, threading through an A36 steel washer that has a tapered center hole to enable countersinking. The tapered steel washer is also designed with a tapered bottom side on its outer diameter, allowing it to countersink into the tapered hole at the joining corner of the crane mat, while a rubber or suitable material washer of any necessary thickness is placed between the tapered steel washer and the nut.

In a particular illustrative embodiment of the invention, a modular assembly of crane mats crane mats are fabricated from recycled wind turbine spar materials, cut, perforated, and assembled into structural modules. Each mat features pre-drilled, beveled corners to facilitate hardware insertion. A union plate is provided. The union plate material: Constructed of ¼-inch A36 steel or equivalent. The unition plate is rectangular with four perforated holes aligned with the mat corners. The union plate has perforations designed to be suitable for coarse threaded nuts or threaded receiver inserts, which may be welded or mechanically fixed. The union plate has alignment notches, near perforations, assist in positioning and orientation during assembly.

In a particular illustrative embodiment of the invention, for Joining Two Mats in Series the union plate is positioned over the perforations at the mat corners. Only two receiver nuts (embedded or welded) are used per connection. Nuts are secured within the perforations, providing a threaded receptacle for bolts. In a particular illustrative embodiment of the invention, Securing the Mat to the Union Plate uses hardware: tapered bolt: Typically about 0.75-inch diameter or as suitable, threaded at one end; a Rubber Washer: Placed over the bolt to cushion and provide flexibility; and a Tapered Steel Washer: Features a tapered center hole, enabling countersinking into the mat's beveled corner.

In a particular illustrative embodiment of the invention, a process for using the invention is as follows: insert the bolt through the rubber washer, then through the tapered steel washer; insert into the pre-drilled, beveled mat corner hole; thread into the embedded or welded nut in the union plate; and tighten the bolt to compress the mat against the union plate, ensuring stable load transfer.

In a particular illustrative embodiment of the invention, a Locking Mechanism is provided. The tapered steel washer sinks into the mat material upon tightening, providing a flush, secure fit. The welded or embedded nut in the union plate mechanically secures the assembly. Tightening the bolt compresses the mat, union plate, and hardware into a rigid joint capable of high load transfer.

In a particular illustrative embodiment of the invention, a union plate is provided configured for a Multi-Mat and 4-Way Assembly. Special 4-way union plates with four perforations enable connecting four mats in a grid configuration. Notches and perforations assist in orientation and alignment. Additional hardware supports flexible and complex arrangements.

In a particular illustrative embodiment of the invention, Additional Features include but are not limited to surface reinforcement plates (from ⅛″ to ½″ thickness) can be welded or fastened to enhance durability. The hardware components are designed for resistance to environmental factors and are reusable, adjustable, and compatible with varying mat thicknesses.

In some aspects, the techniques described herein relate to a fastening system for constructing crane mats from recycled wind turbine blades including: a plurality of crane mats; a tapered crane mat hole in each of the plurality of crane mats; a union plate with perforated holes configured to align with crane mat hole; threaded receiver nuts within the perforated holes of the union plate; and a tapered bolt configured to engage the receiver nuts wherein the fastening system is configured to attached at least 2 of the plurality of crane mats.

In some aspects, the techniques described herein relate to a fastening system, further including: a tapered washer having a tapered diameter wherein the tapered diameter is configured to fit in the tapered crane mat hole.

In some aspects, the techniques described herein relate to a fastening system, wherein the tapered bolt is configured to fit in flush within the tapered washer.

In some aspects, the techniques described herein relate to a fastening system, wherein the tapered washer fits into the tapered crane mat hole.

In some aspects, the techniques described herein relate to a fastening system, wherein the crane mat is configured as a rectangular shape having crane mat corners and wherein the tapered crane mat hole is configured at the crane mat corners. In some aspects, the techniques described herein relate to a fastening system, further including: a rubber washer configured to fit on a tapered bolt. In some aspects, the techniques described herein relate to a fastening system, wherein the union plate is further fitted with alignment notches near the perforations to facilitate proper orientation during assembly.

In some aspects, the techniques described herein relate to a fastening system, wherein the receiver nuts are mechanically fixed within the perforations to provide a permanent threaded receptacle. In some aspects, the techniques described herein relate to a fastening system, further including a 4-way union plate configured to connect four mats in a grid pattern, each with four perforated corners and corresponding embedded nuts.

In some aspects, the techniques described herein relate to a fastening system, further including: a tapered hole in crane mat corner wherein a tapered washer fits into the tapered hole in the crane mat designed to sink into a beveled edge of the tapered hole in the crane mat, configured to provide a flush, secure fit to the crane mat configured to enhance load transfer. In some aspects, the techniques described herein relate to a fastening system, wherein the tapered bolt has a diameter that ranges from 0.75 inches to 1.5 inches, and a length is adjustable to accommodate varying crane mat thickness.

In some aspects, the techniques described herein relate to a system, further including surface reinforcement plates between ⅛ inch and ½ inch thick, attachable to a crane mat surface via welding or fasteners, to support increased load capacity and durability. In some aspects, the techniques described herein relate to a fastening system, wherein the union plate and bolts are configured as corrosion resistant.

In some aspects, the techniques described herein relate to a fastening system, wherein the fastening system is configured to allow for reusability and easy disassembly, enabling mats to be rearranged or relocated without significant degradation of hardware integrity.

In some aspects, the techniques described herein relate to a fastening system, wherein the union plate, bolts, washers, and nuts are compatible with variable mat thicknesses, providing high adaptability for different recycled wind turbine blade segment dimensions.

In some aspects, the techniques described herein relate to a fastening system, wherein the union plate is configured in a rectangular shape. In some aspects, the techniques described herein relate to a method for assembling a load-bearing surface using the fastening system, including: aligning mats' beveled corners with the union plates; inserting the tapered bolts through washers and crane mat corners; engaging the bolts with embedded receiver nuts; and tightening bolts to secure the mats in a desired configuration. In some aspects, the techniques described herein relate to a method, further including: attaching additional reinforcement plates for increased support.

1. A fastening system for constructing crane mats from recycled wind turbine blades comprising:
a plurality of crane mats;
a tapered crane mat hole in each of the plurality of crane mats;
a union plate with perforated holes configured to align with the tapered crane mat hole; threaded receiver nuts within the perforated holes of the union plate; and
a tapered bolt configured to engage the receiver nuts wherein the fastening system is configured to attached at least 2 of the plurality of crane mats.

2. The fastening system of claim 1, further comprising:
a tapered washer having a tapered diameter wherein the tapered diameter is configured to fit in the tapered crane mat hole.

3. The fastening system of claim 2, wherein the tapered bolt is configured to fit in flush within the tapered washer.

4. The fastening system of claim 2, wherein the tapered washer fits into the tapered crane mat hole.

5. The fastening system of claim 1, wherein the crane mat is configured as a rectangular shape having crane mat corners and wherein the tapered crane mat hole is configured at the crane mat corners.

6. The fastening system of claim 1, further comprising:
a rubber washer configured to fit on a tapered bolt.

7. The fastening system of claim 1, wherein the union plate is further fitted with alignment notches near the perforations to facilitate proper orientation during assembly.

8. The fastening system of claim 1, wherein the receiver nuts are mechanically fixed within the perforations to provide a permanent threaded receptacle.

9. The fastening system of claim 1, further comprising a 4-way union plate configured to connect four mats in a grid pattern, each with four perforated corners and corresponding embedded nuts.

10. The fastening system of claim 1, further comprising:
a tapered hole in crane mat corner wherein a tapered washer fits into the tapered hole in the crane mat designed to sink into a beveled edge of the tapered hole in the crane mat, configured to provide a flush, secure fit to the crane mat configured to enhance load transfer.

11. The fastening system of claim 1, wherein the tapered bolt has a diameter that ranges from 0.75 inches to 1.5 inches, and a length is adjustable to accommodate varying crane mat thickness.

12. The system of claim 1, further comprising surface reinforcement plates between ⅛ inch and ½ inch thick, attachable to a crane mat surface via welding or fasteners, to support increased load capacity and durability.

13. The fastening system of claim 1, wherein the union plate and bolts are configured as corrosion resistant.

14. The fastening system of claim 1, wherein the fastening system is configured to allow for reusability and easy disassembly, enabling mats to be rearranged or relocated without significant degradation of hardware integrity.

15. The fastening system of claim 1, wherein the union plate, bolts, washers, and nuts are compatible with variable mat thicknesses, providing high adaptability for different recycled wind turbine blade segment dimensions.

16. The fastening system of claim 1, wherein the union plate is configured in a rectangular shape.

17. A method for assembling a load-bearing surface using the fastening system of claim 1, comprising:
aligning mats' beveled corners with the union plates;
inserting the tapered bolts through washers and crane mat corners;
engaging the bolts with embedded receiver nuts; and
tightening bolts to secure the mats in a desired configuration.

18. The method of claim 17, further comprising:
attaching additional reinforcement plates for increased support.
